(19) United States
(12) Patent Application Publication
(10) Pub. No.: US 2009/0232939 A1
(43) Pub. Date: Sep. 17, 2009

(54) COMPOSITION COMPRISING SUGAR AND SALT FOR TREATING MEAT

(75) Inventor: Erik Magistad Berge, Rasta (NO)

Correspondence Address: SCHNECK & SCHNECK, P.O. BOX 2-E, SAN JOSE, CA, 95109-0005, US

(73) Assignee: FJELL & FJORD MAT AS, Ron i Valdres (NO)

(21) Appl. No.: 12/162,007

(22) PCT Filed: Jan. 22, 2007
(86) PCT No.: PCT/NO07/00021

§ 371 Date: Jul. 24, 2008

(30) Foreign Application Priority Data
Jan. 24, 2006 (NO) 20060371

(51) Int. Cl. A23L 1/31; A23L 1/30

(52) U.S. Cl. 426/56; 426/332; 426/641; 426/648

(57) ABSTRACT

The present invention relates to a composition comprising a mixture of sugar and salt for treating meat. Treating meat either by penetration of said composition through the meat or by fermenting the meat in a closed container, results in a meat product with a salty taste throughout. Processes using lactic acid fermentation and process for producing storage-stable meat products are also disclosed.

### AMBIT OF THE INVENTION

The present invention is concerned with a combination of salt and sugar for treating meat providing a meat product with an improved storage capability as well as improved consumer safety by the sugar/salt combination as well as providing favourable growth conditions for lactic acid bacteria at low temperatures.

### PRIOR ART

When producing a meat product with a prolonged storage time as well as when producing further treated meat products from such sugar-treated products, e.g. fermented meat, meat jerky, minced meat, ground meat etc., a fresh piece of meat material will first be treated with sugar. The pre-treatment of the meat with sugar, such as known from e.g. U.S. Pat. No. 5,607,713, causes an increase of the solid matter content ratio (the dry matter content) in the meat. Here it is also stated that there arises a decrease in the proportion of organic acids while the microbiological purity simultaneously is maintained in the meat. Such a treatment includes that the meat, either in fresh, pre-treated (e.g. irradiated) or stored (frozen/thawed) condition is brought into contact with sugar, preferably in the form of a powder, whereby there is formed an exudate (extract). This exudate comprises an aqueous extract from the meat wherein there has been included heavy metals, toxins, degradation products etc. which largely comprise waste materials. Such waste materials may be formed during the slaughtering of animals. In live or slaughtered animals there exist several organic and biochemical reactions for creating waste materials such as the creation of acids at the entrance of rigor mortis, while the quality of the meat will be dependent on the condition of the slaughter animal prior to slaughtering (stress, feed, exercise, etc). Such reactions may produce bad taste, smell or consistency of the meat.

It will especially also be mentioned that unwanted natural taste compounds being present in the meat, e.g. taste being present in the meat from animals in heat such as reindeer, sheep, pigs, cattle etc. or e.g. small/taste of breeding pens/barns, may be removed through the processing of such meat with sugar.

The sugar treatment mentioned supra will remove all or parts of such waste compounds and taste-degrading substances in addition to said toxins and heavy metals. Such unwanted substances will be present in the exudate from the meat after the treatment. This exudate is discarded. Such a sugar treatment of meat is previously known from U.S. Pat. No. 5,607,713 where there is disclosed saccharose treatment of meat for improving its storage capability.

It will also be possible to perform the sugar treatment disclosed supra on meat that has been frozen.

Sugar, in the context of the present invention, is meant to encompass mono-, di- or oligo- or polysaccharides, e.g. saccharose, fructose, mannose, maltose etc., preferably saccharose or fructose, or a mixture thereof, and the sugar may be present in the form of a powder, a granulate or a solution. Also sugars with a low metabolic reaction rate and consequently a low calorie content such as palatinose, may be used. An example of a sugar product that does not have any sweet taste is trehalose.

In connection with the expression “meat” this will in the context of the present invention be understood to include all forms of meat from land-dwelling animals (bovines, procines, ovines, etc.) as well as water-dwelling fish. It is preferred that the meat originates from livestock, cattle, pig, game (moose, reindeer, deer, etc), birds (turkey, chicken, grouse, capercaille, etc.) or fish (herring, salmon, trout, halibut, cod, etc.).

The advantage of treating meat with sugar is that thereby it is used a process that is reproducible, does not degrade the structure of the meat and improves the organoleptic properties (taste) since the exudate contains unwanted taste substances in addition to a substantial part of the used sugar.

In addition it is avoided that there is employed a starting material that has been added conservatives since many conservatives either enter into reactions with substances in the meat (proteins, lipids, sugars, etc.), are introduced into the chain of nutrition or both. Reaction products between conservatives and the meat or the conservatives per se may be difficult to degenerate in the body and/or their secretion from the body may be difficult, further representing a health or environmental hazard.

In the open sugar treatment of the relevant meat there is formed an exudate that is discarded whereby the treatment time of the meat is adjusted in relation to the mass/size of the meat. The open treatment of the meat with a sugar or sugar composition is done by placing the meat on a surface such as a grate or screen, and where the top of the meat is covered q.s. with the relevant sugar (however, in such a way that the sugar does not fall off the meat in substantial quantities). The sugar will subsequently (depending on the thickness of the piece of meat, the meat quality, the type of meat etc. something that easily may be determined/considered by the person skilled in the art) dissolve in the meat juices and slowly penetrate the piece of meat and carry along the harmful and unwanted components being mentioned supra.

As a guideline it may be indicated that the meat is to be treated openly in a time interval of 1-7 hours per cm thickness of the individual piece of meat, more preferred 2-5 hours per cm thickness of the piece of meat, most preferred 3-4 hours per cm thickness of the piece of meat. However, these intervals are given as a guideline since, as mentioned supra, other factors than the thickness of the piece of meat interact in determining the time of the sugar treatment. Generally, however, it may still be mentioned that the open sugar treatment is ended when there does not appear any more sugar-containing exudate from the piece of meat, and this may be observed directly or be determined empirically for the relevant type/quality/thickness of the piece of meat.

In addition to unwanted/harmful substances being drawn from the meat through the sugar treatment, it also seems that other components are carried out together with the sugary exudate. For instance it seems that degradation enzymes such as proteases and lipases may be drawn out and discarded with the exudate. Without being limited by any theory it may seem that this kind of treated meat forms a starting material for continued treatment of meat that is significantly different form conventional meat.

The above described process represents an open process, i.e. a process wherein the exudate from the sugar-treatment may be removed freely.

Furthermore, according to the present invention, lactic acid bacteria multiply on the meat having been treated with sugar as indicated supra. Said lactic acid bacteria may also reduce the deterioration of the meat product by lowering the pH of the meat, by providing an environment being unfavourable for the growth of other (harmful or degrading) bacteria and fungi, provide special (favourable) taste qualities to the meat, etc. This will be accounted for in greater detail infra.

The temperature interval whereby the meat is kept during both the closed and open sugar treatment according to the present invention lies in the temperature interval between 0° C. and ambient temperatures, e.g. in the interval 0-20° C., more preferred 4-15° C., even more preferred 4-10° C., most preferred 4-6° C.

### GENERAL DISCLOSURE OF THE INVENTION

For obtaining a sugar-treated meat product as indicated supra, wherein the meat subsequently to the sugar treatment either is to be consumed directly or is subjected to a further processing/treatment (see supra), it will be necessary to add salt as a taste enhancer or as a spice per se (since part of the taste substances in the meat have been removed through the open sugar treatment). The problem forming a basis for the present invention is that such salt that subsequently is added to the pre-sugar treated meat, does not enter into the meat correctly on account of the somewhat dry condition of the meat since part of the meat juices/water is removed via the exudate being formed and discarded after the open sugar treatment.

Also for post-treatment of such sugar-treated meat, e.g. for producing fermented/cured meat, it will be required to add salt, optionally in addition to other spices/taste additives/taste enhancers. As an example it will be mentioned that a fermented fish product may contain from 0.5 to 10% (v/v) salt, and a cured meat product may contain from 0.5 to 10% (v/v) salt. Also, on account of the somewhat bland taste of the sugar-treated meat resulting from some of the taste substances being removed through the sugary exudate, it is preferred to add salt to the meat.

It has now surprisingly been found that an addition of salt may be performed already at the initial sugar treatment step of the meat. By adding salt in the initial sugar material/composition the salt will penetrate into the meat together with the sugar to a far greater extent than if it was added subsequently to the sugar treatment. Surprisingly it was found that that the meat has a salty taste after the initial sugar treatment step if a salt/sugar composition was added at the initial treatment step. The present invention thus concerns a salt/sugar composition being suitable as a treatment composition for obtaining sugar-treated meat with a prolonged storage capacity, and wherein a part of the originally added salt remains in the meat after the sugar-treatment is ended.

Specifically such a sugar/salt composition wherein the sugar may be present in the form of sugar-types or mixtures thereof as indicated supra, and the salt may be present in the form of sodium chloride, but also in the form of sea salt or a salt composition such as a mixture of sodium chloride/potassium chloride/magnesium chloride for reducing the amount of sodium in the salt, may have a ratio between the sugar/salt of 20/80 (w/w), more preferred 50/50 (w/w), even more preferred 80/20 (w/w), e.g. 60/40 (w/w) or any ratio between these values. These ratios relate to an open treatment of the meat where much of the salt as well as the sugar is removed through the exudatem and they also relate to a closed treatment with a salt/sugar composition wherein a much smaller amount of salt and sugar is used since the exudate in a closed treatment is not removed until the container (closed plastic bag) is opened and consequently wherein especially the salt component adds a salty taste to the meat. A salt component of at most 10% (w/w calculated from the weight of the meat) is recommended.

When adding a composition of salt/sugar in the initial meat treatment step it has also been found that there occurs a significant rise in the count of lactic acid bacteria in the salt/sugar-treated meat. This is very surprising and advantageous since the presence of lactic acid bacteria even further enhances the storage capacity of the meat product.

The presence of lactic acid bacteria in the sugar-treated meat is furthermore especially surprising since the treatment is conducted at low temperatures (conventionally at refrigeration temperatures (0-10° C., e.g. 4-6° C.)) and at elevated ionic strength through the presence of added salt (see supra), and such conditions are normally not very conductive for the growth of such bacteria.

Additionally the removal of parts of the water from the meat through the sugar treatment (the removal of the exudate) will leave the meat in a state of low water-activity, also being poorly conductive for the growth of bacteria. From this aspect the presence of lactic acid bacteria is thus thoroughly surprising.

Also, if a further treatment of the sugar-treated meat is to be conducted, one such post-treatment step may be producing fermented meat, and the presence of lactic acid bacteria also enhances and speeds up such a fermentation process. The said fermentation is, however, performed under a soft vacuum (e.g. 100-500 mm Hg), and the growth of lactic acid bacteria is also surprising under these conditions. It is thus possible to place sugar-treated pieces of meat that have been subjected to an open sugar/salt treatment in plastic bags for further fermentation under a soft vacuum and at refrigeration temperatures. When fermenting such pre-treated open treated salt/sugar-containing meat it is, however, not always possible to know the exact amount of sugar or salt that remains in the material prior to the fermentation.

It has consequently also surprisingly been found that for producing a salty and sugar-treated meat product it is possible to place a salt/sugar composition at the correct amount of salt (and not q.s.) in a vacuum plastic bag and placing the bag under a soft vacuum (see supra). Obviously, if a non-treated piece of meat is placed in a closed container (e.g. a plastic vacuum bag) together with the correct amount of salt and sugar, an exudate will not be removed from the meat. Such a process is, however, advantageous since it now will be possible to add an exact amount of sugar to be fermented by the lactic acid bacteria, and an exact amount of salt may also be added since the system is closed. As before, however, both the salt and the sugar penetrate the meat material during the treatment solving the problem with the somewhat dry character of the meat subsequent to the open sugar treatment.

On account of growth of lactic acid bacteria inside the vacuum bag the sugar will be consumed leaving the salt to enhance the flavour of the meat. The starting material for such a treatment can be either fresh meat or meat that has been pre-treated with sugar as disclosed supra. Also the salt is distributed evenly throughout the meat during the vacuum treatment period even though the salt/sugar composition is placed at one spot inside the vacuum bag prior to the vacuuming and refrigeration of the bag.

If a closed bag salt/sugar treatment with fresh meat is performed, the amount of salt should not exceed 10% (w/w) based on the weight of the piece of meat to be treated. The amount of salt will under such closed-system conditions normally lie in the interval 2-5% (w/w), although also other amounts may be possible such as 1%, 3%, 7%, 10% (w/w) etc.

In an open system salt/sugar treatment it is also preferred that the salt content of the finished product does not exceed 10% (although this is harder to control than in the closed system environment, see supra).

The open treatment of meat with a salt/sugar composition thus has a multiple advantage both through the simultaneous addition of salt during the sugar treatment and also as an enhancer for providing suitable growth conditions for subsequent growth of lactic acid bacteria in the meat.

By adding the salt/sugar composition to the meat according to the present invention it will also be possible to add other spices and taste enhancers to the meat after the salt/sugar treatment has ended in the open system treatment mode or simultaneously with the salt/sugar composition in the closed system mode. Examples of such spices/taste enhancers are pepper, nutmeg, ginger or mixtures of spices, fruit (fresh/dried) such as apple, pear, pineapple, papaya, dates, figs etc., vegetables such as carrot, horse radish, turnips, radish etc, and also herbs. Other taste additions may also be introduced in the form of essences (whiskey essence, rum essence, etc).

The condition of the end product treated according to the present invention (taste, smell, texture, colour, etc.) depends on the selection of the above indicated factors such as the added amount of salt and/or spices and/or taste enhancers (or other components such as colorants), the treatment temperature, the treatment period, etc. However, since the condition of the end product also depends on the taste of the consumer, the determination of the strength and duration of the treatment or post-treatment process will be individual, but the determination of the quality of the end product may easily be found through routine tests and the knowledge of the person skilled in the art. By operating within the above mentioned parameters the person skilled in the art may easily produce a product having the required taste, smell and texture.

As a guideline for the duration of the treatment of the meat with a salt/sugar composition in a closed system (vacuum container) for providing a fermented and salt-including end product where it is used a salt/sugar composition with salt within the interval indicated supra (up to 10% (w/w), preferably within the interval 2-5% (w/w), e.g. 2-3% (w/w) calculated on the weight of the piece of meat), this will normally lie within the interval 1.5-2 days per kg meat.

The amount of sugar to be added in the salt/sugar composition will relate to the salt/sugar ratios given in the disclosure supra. This will provide a suitable environment for lactic acid bacteria to grow.

The duration of the salt/sugar and lactic acid bacteria treatment in a closed system under vacuum according to the present invention may, however, be longer or shorter than what is indicated supra depending on the wanted state of the end product, the temperature at which the treatment is performed, the type of meat that is processed (normally fermentation of fish meat takes a shorter time than the fermentation of meat from land-dwelling animals and there may even be variations within e.g. the species of animal meat that is treated) etc. The exact duration of the salt/sugar treatment/fermentation may be determined by the person skilled in the art through observation and by consulting the above given disclosure since the addition of a salt/sugar composition in a known amount in a closed system will provide a stable and predictable environment for the fermentation to proceed in. However, no extraordinary actions need to be carried out for establishing the wanted duration of the treatment in view of the above given disclosure and guidelines, and also based on the examples given infra.

By the treatment of the meat with the salt/sugar composition according to the present invention, and optionally subsequently through the growth of lactic acid bacteria for further processing the salt/sugar treated meat, there will be formed meat products with hitherto unknown qualities, i.e. with simultaneously included salty taste, with the properties of the formerly known sugar-treated meat being suitable for further processing steps, e.g. as indicated supra, and different meat products with special taste properties on account of the action of the lactic acid bacteria. The use of the salt/sugar composition for producing a salty and storage-stable meat product is also considered to be novel and not obvious to the person skilled in the art. Likewise the process of producing a salty and sugar-treated meat product by placing the relevant piece of meat onto a surface such as a grid, add the salt/sugar composition onto the surface of the meat and subsequently remove the formed exudate for providing a storage stable salty meat product, is considered to be novel and not obvious for a person skilled in the art. Further, the closed system process of providing a sugar-treated, fermented and salty meat product as disclosed supra is considered to be novel and inventive. It will also be referred to the non-limiting examples given infra.

Concerning the growth of lactic acid bacteria, such bacteria will proliferate spontaneously during the salt/sugar treatment providing the advantageous effects indicated supra. However, it may be advisable to add a starter culture of lactic acid bacteria to the meat to ensure that growth of other bacteria is quenched through selection and competition with the lactic acid bacteria. Such a starter culture may be added to the meat before or after the removal of the exudate in the open treatment mode or simultaneously with the addition of the salt/sugar composition in the closed system mode. A starter culture of lactic acid bacteria may be any purchased lactic acid starter culture or may alternatively originate from previous fermentations according to the present invention, e.g. through the addition of fluid from the closed system fermentation bags. The amount of starter culture to be added will normally lie in the range of 1-10 ml and is not critical since the growth of the lactic acid bacteria only needs an initial boost to overwhelm and inhibit the growth of other bacteria in the system.

### EXAMPLE 1

### Open Conditions

Fresh halves of salmon with an individual weight of 1-4 kg prepared according to common practice within the meat industry (quartered, de-boned, filleted, etc.) were placed on a screen of polyamide and their upper surfaces were covered homogenously with a composition of 80 parts by weight of saccharose powder and 20 parts by weight of sodium chloride in an amount so that the composition just does not fall off. The saccharose dissolves together with the salt into the meat juices and an exudate is formed. This exudate is removed through drainage. After this treatment the meat maintains a salty flavour and is suitable for further treatment such as producing a fermented fish meat product or ground fish meat/surimi that also may be further treated, e.g. dried.

The treated meat has a distinct, but not overwhelming, salty taste.

### EXAMPLE 2

### Open Conditions

Fresh pieces of thigh from sheep with an individual weight of 5-10 kg prepared according to common practice within the meat industry, are placed on a screen of polyamide and their upper surfaces are covered with a composition of saccharose powder (50 w/w) and sea salt 50% (w/w) so that it does not fall off. The composition dissolves in the meat juices and is drained away as an exudate. After 20 hours of this treatment the salt/sugar-treated meat is ground into mince with the addition of a spice mixture in an amount of 20 grams. The minced meat is simultaneously added an amount of 2 litres water to form a supple material, and this material is pressed into sausage skins made from intestines with a diameter of 3 cm. The sausage skin is knotted into conventional lengths for forming sausages of a common size. These sausages are hung for curing at a temperature of 4-10° C. after a short (2 hours) initial heating to about 15° C. After a curing time of 2-3 weeks the sausages are finished curing to a consumable product.

The sausages have a distinct, but not overwhelming, taste of salt together with a taste of the mixture of spices. Furthermore, the sausages have no taste of sugar due to a rise in the count of natural lactic acid bacteria present in the sausages that convert the sugar to lactic acid and lactic acid products.

### EXAMPLE 3

### Open Conditions

Fresh thighs from pigs (ham) with an individual weight of 8 kg and prepared in accordance with common practice within the food industry, are placed on a screen of polyamide and their upper surfaces are covered homogenously with a composition of saccharose powder 70% (w/w) and a mixture of sodium chloride/potassium chloride/magnesium chloride (50/48/2) 30% (w/w) so that it does not fall off. The composition dissolves in the meat juices and the exudate that forms is drained away. After 3-6 days it is formed a fully consumable product with an improved storage capacity and with good organoleptic properties and with a distinct salty taste.

### EXAMPLE 4

### Open Conditions

Fresh thighs from pigs (ham) with an individual weight of 8 kg and prepared in accordance with common practice within the food industry, are placed on a screen of polyamide and their upper surfaces are covered homogenously with a composition of saccharose powder 70% (w/w) and a mixture of sodium chloride/potassium chloride/magnesium chloride (50/48/2) 30% (w/w) so that it does not fall off. The composition dissolves in the meat juices and the exudate that forms is drained away. After 3-6 days it is formed a product that is treated further for curing. After an initial warning to 10-20° C. for 1-2 days, the ham is hung for curing at 6-10° C. The curing process proceeds for 4-12 weeks. After this period of time the fully cured meat has a distinct, but not unpleasant salty taste. No sweet taste was detected in the cured ham, but there was noted a rise in the count of lactic acid bacteria throughout a cross section of the ham.

### EXAMPLE 5

### Open Conditions

Fresh thighs from pigs (ham) with an individual weight of 8 kg and prepared in accordance with common practice within the food industry, are placed on a screen of polyamide and their upper surfaces are covered homogenously with a composition of saccharose powder 70% (w/w) and a mixture of sodium chloride/potassium chloride/magnesium chloride (50/48/2) 30% (w/w) so that it does not fall off. The composition dissolves in the meat juices and the exudate that forms is drained away. Then a starter culture of lactic acid bacteria was added to the meat. After 3-6 days it is formed a product that is treated further for curing. After an initial warming to 10-20° C. for 1-2 days, the ham is hung for curing at 6-10° C. The curing process proceeds for 4-12 weeks. After this period of time the fully cured meat has a distinct, but not unpleasant salty taste. No sweet taste was detected in the cured ham, but there was noted a rise in the count of lactic acid bacteria throughout a cross section of the ham.

### EXAMPLE 6

### Open Conditions

Fresh pieces of thigh from cattle (bull) with an individual weight of 1.5-3.0 kg were treated with a salt/sugar composition (80% sugar/20% salt (w/w)) for 1-2 days. The formed exudate is discarded. The salt/sugar-treated meat is added heat to maximally 20° C. for 12-24 hours, whereupon they are placed on a screen for drying at 6-10° C. The pieces of meat are cut into thin meat slices of 3 cm after 5 days, and these are further dried for 1-7 days at 6-10° C. at low relative humidity (under 60%), whereupon the meat is finished drying. The meat is cut into pieces of 2.3 mm thickness and are added a mixture of spices, e.g. pepper/oregano, and is packaged as snacks.

### EXAMPLE 7

### Closed Conditions

Pieces of trout each weighing 1-2 kg were placed individually in plastic vacuum bags. In two thirds of the bags there was added a salt/sugar composition consisting of 7 g salt (sodium chloride) and 20 g sugar (saccharose). In the last third no addition was made. All the bags were closed and subsequently placed under a vacuum of 550 mm Hg and placed in a refrigerator at a temperature of +4° C. This vacuum and temperature was kept for a period of 14 days for one half of the sugar/salt-treated bags and for the non-sugar/salt-treated bags. The rest of the bags were divided into two groups where one group was kept under the existing vacuum for a total period of 1 month and the other for a total period of two months.

To illustrate and document the effect of the development of lactic acid bacteria, the results from these tests are presented in table 1 infra for a better overview.

### EXAMPLE 8

### Closed System

The same test as disclosed in Example 6 was conducted, but this time on pieces of ham with an individual weight of 2 kg. The results from this test are given in table 1 infra.

TABLE 1

| | | | | Count of lactic |
|---|---|---|---|---|
| Starting material | Pre-treatment | Storage time | | acid bacteria |
| Trout | Untreated | 14 | days | 1.9 · 10⁴ |
| Trout | Sugar-treated | 14 | days | 2.3 · 10⁴ |
| Trout | Sugar-treated | 1 | month | 7.9 · 10⁷ |
| Trout | Sugar-treated | 2 | months | 2.8 · 10⁷ |
| Ham (pig) | Untreated | 14 | days | 1.2 · 10⁵ |
| Ham (pig) | Sugar-treated, cured | 2 | months | 1.3 · 10⁵ |

For the determination of the count of lactic acid bacteria there was performed a preparation on MRS-agar (de Man, Rosa, Sharp) for 3 days, microaeropile 30° C. The agar contains all the necessary nutrients for growth of lactic acid bacteria. The detection and quantification was performed with a katalase-test (GBA-Food, Staatliche Akkreditierunsstelle, Hannover, Germany).

The above documented rapid development of lactic acid bacteria under the relevant conditions of low temperature and optionally soft vacuum is very surprising, this despite the fact that the growth of the bacteria occurs under a relatively high salt concentration, low temperatures and vacuum.

When opening the bags with the sugar-treated and lactic acid bacteria fermented meat inside after 1 month and 2 months, it was discovered that all of the sugar had been used by the lactic acid bacteria to drive the fermentation. All of the meat tasted good with a characteristic taste of properly fermented meat and with a properly salty flavour. Even the meat having been treated for 14 days had been fermented to an edible product, but the fermentation could have proceeded further.

### EXAMPLE 9

### Closed System

Pieces of trout each weighing 1-2 kg were placed individually in plastic vacuum bags. The bags there were added a salt/sugar composition consisting of 7 g salt (sodium chloride) and 20 g sugar (saccharose), and a starter culture of lactic acid bacteria of 5 ml was added, the starter culture consisting of the exudate formed in the 1 month trout fermentation bags from Example 7. All the bags were closed and subsequently placed under a vacuum of 550 mm Hg and placed in a refrigerator at a temperature of +4° C. This vacuum and temperature was kept for a period of one month. After this treatment period the trout had developed into a nicely fermented product with good smell and taste properties and that might be consumed directly after the opening of the vacuum bags.

### EXAMPLE 10

### Closed System

Pieces of ham each weighing 1 kg were placed individually in plastic vacuum bags. The bags were added a salt/sugar composition consisting of 7 g salt (sodium chloride) and 20 g sugar (saccharose) and a starter culture of lactic acid bacteria of 3 ml was added, the starter culture consisting of the exudate formed in the 2 month ham fermentation bags from example 7. All the bags were closed and subsequently placed under a vacuum of 550 mm Hg and placed in a refrigerator at a temperature of +4° C. This vacuum was kept for a period of one month. After this treatment period the ham had developed into a nicely fermented product with good smell and taste properties and that might be consumed directly after the opening of the vacuum bags.

1. Composition for treating meat comprising a mixture of salt and sugar, characterized in that the sugar and salt are present in a ratio between 80/20 (w/w) and 20/80 (w/w).

2. Composition according to claim 1, characterized in that the sugar is present as pure sugar.

3. Composition according to claim 1, characterized in that the sugar is present as a mixture of two or more of sugars.

4. Meat product, characterized in that it is present in the form of a meat material that has been treated with a salt/sugar composition according to claim 1.

5. Meat product according to claim 4, characterized in that the meat is present as whole pieces of meat.

6. A method of using a salt/sugar composition for the production of a storage-stable meat product, comprising treating meat with a composition of between 20-80% sugar by weight and 20-80% salt by weight; and allowing mixture to contact the meat product such that a count of lactic acid bacteria rises.

7. (canceled)

8. The method of claim 6 further including a final step of further processing the meat product.

9. Process for producing a storage-stable meat product through open conditions, where meat is exposed to air under normal pressure conditions and at a temperature below 20° C. by placing the meat onto a screen, placing a salt/sugar composition having a w/w ratio of between 20:80 and 80:20 on the surface of the meat to establish an exudate; and removing the exudate to create a storage-stable meat product.

10. Process according to claim 9, characterized in that as a starting material said meat is frozen.

11. Process according to claim 9, further including adding a starter culture of lactic acid bacteria before or after salt/sugar treatment of the meat.

12. Process for producing a fermented meat product through use of closed conditions, characterized in that meat is placed inside an air-tight container together with at least a salt/sugar mixture having a w/w ratio of between 20:80 and 80:20 salt to sugar; closing the container; applying a soft vacuum to the container, and placing said meat at a temperature between 0 and 20° C. for a period of time sufficient to ensure growth of lactic acid bacteria.

13. Process according to claim 12, characterized in that the meat is refrigerated to a temperature of 4-8° C.

14. Process according to claim 12, characterized in that an amount of salt not exceeding 15% (w/w salt/meat) is present in the salt/sugar mixture.

15. Process according to claim 14, characterized in that an amount of salt is between 2-3% (w/w) salt and meat is present in the salt/sugar mixture.

16. Process according to claim 12, further including adding to the meat a starter culture of lactic acid bacteria prior to the container being closed.

17. Process according to claim 16, characterized in that the lactic acid bacteria starter culture comprises an exudate collected from prior lactic acid bacteria fermentations.

18. Meat products according to claim 4, characterized in that the meat is present as ground meat.
